(19) United States
(12) Patent Application Publication
(10) Pub. No.: US 2007/0106619 A1
(43) Pub. Date: May 10, 2007

(54) Method of and system for authenticating a transaction initiated from a non-internet enabled device

(76) Inventor: John Charles Holdsworth, Kempton Park (ZA)

Correspondence Address: LADAS & PARRY LLP, 224 SOUTH MICHIGAN AVENUE, SUITE 1600, CHICAGO, IL, 60604, US

(21) Appl. No.: 10/562,773

(22) PCT Filed: Jun. 30, 2004
(86) PCT No.: PCT/IB04/02168

§ 371 Date: Oct. 2, 2006

(30) Foreign Application Priority Data
Jun. 30, 2003 (ZA) 2003/5050

(51) Int. Cl. G06Q 99/00

(52) U.S. Cl. 705/67

(57) ABSTRACT

A method of and system for authenticating a transaction initiated from a non-internet enabled device (101) is disclosed. In broad terms, this invention defines systems and methods that enable Issuers (107), Acquirers and Merchants (105) to use existing online cardholder authentication protocols to authenticate cardholders transacting with non-internet enabled devices. In particular, the invention operates as a proxy on behalf of the cardholder and simulates a conventional cardholder authentication session to a Merchant Plug-in (105) and Issuer ACS (107). That is, it converts voice or data based messages received from non-internet enabled devices (101) into a format that is consistent with the requirements of the existing online cardholder authentication protocols.

### FIELD OF THE INVENTION

THIS invention relates generally to a method of and system for conducting financial transactions, and more specifically to the authentication and authorisation of mobile payment transactions initiated from non-internet enabled devices.

### BACKGROUND OF THE INVENTION

Mobile telecommunications continues to be very successful, with an estimated one billion mobile subscribers by the end of 2002 (Source: The Universal Mobile Telecommunications Service (UMTS) Forum). The success of NTT DoCoMo's i-mode service in Japan, which currently has 34 million data subscribers, illustrates the appetite for mobile data services. In addition, the rapid uptake of short messaging services (SMS) has demonstrated the demand for non-voice services. A joint survey by Visa International and Boston Consulting predicts that combined e-commerce and m-commerce volumes will grow from $38 billion in 2002 to $128 billion in 2004.

In the meantime, high speed data networks, with more sophisticated wireless devices have the ability to transform mobile payment. Greater bandwidth, larger screens, colour displays, longer battery life and compelling content are converging to create an environment where consumers can purchase services and products on the move. However, the success of both e-commerce and m-commerce is contingent on the same factors that have fuelled the growth of physical payments, namely security and privacy. Virtual payments, whether executed via a personal computer or a mobile phone, must be subject to the same common standards that govern physical payment card use in order to be perceived as familiar and secure.

In response to this need, the card associations have developed new online cardholder authentication standards and have globally mandated that from the 1^{st} of April 2003, Acquirers of payment card transactions must offer to their online merchants the new standards such as the 3-Domain Secure (3-D Secure™) protocol which has been developed by Visa International and licensed to MasterCard. In short, the 3-D Secure™ protocol is an e-commerce protocol that enables the secure processing of payment card transactions over the Internet.

The objectives are to provide Issuers with the ability to authenticate cardholders during an online purchase. This will enable all parties in the transaction to transmit confidential and correct payment data and provide authentication that the buyer is an authorized user of a particular card.

It is thus a general aim of the 3-D Secure™ protocol to reduce the number of disputed online purchases, by enabling Issuers to verify that the person making an e-commerce purchase is an authorized cardholder. This verification process is also referred to as “payment authentication.” For the purposes of the present invention:
1. An Issuer is defined as a financial institution that issues a payment card to a person (or cardholder), contracts with the cardholder to provide card services, and determines the eligibility of the cardholder to participate in a transaction.
2. An Acquirer is defined as a financial institution that establishes a contractual service relationship with a merchant for the purpose of accepting payment card.
3. A Merchant is an entity that contracts with an Acquirer to accept payment cards and manages the online shopping experience of the cardholder, obtains the card number and then transfers control of the transaction to a Merchant Server Plug-in, which then conducts payment authentication.
4. The Merchant Server Plug-in is integrated into a merchant's existing commerce server, is able to obtain cardholder information and is able to access the Issuer's Access Control Server to validate the payment card's participation in the transaction.
5. The Access Control Server (ACS) is a component that operates in the domain of the Issuer, verifies whether authentication is available for a card number and authenticates specific transactions.

In a nutshell the operation of the 3-D Secure™ protocol operates as follows:
1. The cardholder selects goods or services from the Merchant's web site, and proceeds to the Merchant's checkout page.
2. The Merchant Server Plug-in sends a message to a Card Directory Service to determine whether authentication is available for the card number. If so, the Card Directory Service queries the appropriate Issuer ACS to validate cardholder participation and sends the response back to the Merchant Server Plug-in.
3. The Merchant Server Plug-in then sends an authentication request to the ACS via a cardholder browser.
4. The ACS queries the cardholder for a password. The cardholder enters the password and the ACS verifies it.
5. The ACS returns the authentication response to the Merchant Server Plug-in via the cardholder browser.
6. The Merchant Server Plug-in validates the response.
7. If appropriate, the merchant proceeds with authorization exchange with its Acquirer.

The 3-D Secure™ protocol specification defines an architecture and protocol for authenticating cardholders during Internet-based transactions. In other words, the 3-D Secure™ protocol has been designed for the support of “Internet shopping”, where the cardholder is shopping using their Internet-enabled device, and the authentication takes place over the Internet. It would therefore be desirable to provide a method of and system for conducting financial transactions initiated from non-internet enabled devices, which preferably utilize the existing 3-D Secure™ protocol technology and platforms currently available.

### SUMMARY OF THE INVENTION

In broad terms, this invention defines systems and methods that enable Issuers, Acquirers and Merchants to use the 3-D Secure™ online cardholder authentication protocol to authenticate cardholders transacting with non-internet enabled devices. The invention operates as a proxy on behalf of the cardholder and simulates a core 3-D Secure™ session to the Merchant Plug-in and Issuer ACS. That is, it converts voice or data based messages received from non-internet enabled devices into a format that is consistent with the requirements of the 3-D Secure™ protocol. Further, the invention can be implemented without Issuers, Acquirers or Merchants having to upgrade or enhance infrastructure.

According to a first aspect of the invention there is provided a method of authenticating a transaction initiated from a non-internet enabled device by a cardholder, the method comprising the steps of:
submitting a purchase request message from the non-internet enabled device over a first network to a mobile operator control means;
converting the purchase request message to a format that is readable by a virtual cardholder control means;
extracting a unique identifier from the purchase request message and matching it with a corresponding value stored in a remote database;
extracting cardholder data stored in the remote database; sending an authentication request message to an Issuer access control means;
sending a purchase authentication page from the Issuer access control means to the virtual cardholder control means;
extracting displayable information and storing the purchase authentication page;
prompting the cardholder to enter his or her credentials; converting the cardholder credentials to a format that is readable by the virtual cardholder control means;
parsing the stored purchase authentication page and recognizing the cardholder credential field(s);
inserting the credentials into the purchase authentication page; sending the populated purchase authentication page to the Issuer access control means;
authenticating the cardholder credentials against an account holder database; and
responding to the virtual cardholder control means with an authentication response message.

Preferably, the method includes the further steps of:
forwarding the authentication response message to a Merchant control means;
decoding and validating the authentication response; and
generating an authorization request message and sending it to an Acquirer.

Conveniently, the non-internet enabled device is selected from the group comprising: mobile telephones, landline telephones, Personal Digital Assistants (PDA's) and laptop computers.

Typically, the technology used to submit a purchase request is taken from the group comprising: an Interactive Voice Response (IVR), Short message Services (SMS), SIM Toolkit (STK), Unstructured Supplementary Services Data (USSD) and Wireless Application Protocol (WAP).

Preferably, the first network makes use of a plurality of wired and/or wireless network transport mechanisms to route the purchase request, the plurality of network transport mechanisms including GSM, CDMA, TDMA, GPRS, 3G, Bluetooth, Infrared, RFID and PSTN.

Conveniently, the cardholder credentials are selected from a group comprising a PIN, user Id and/or password, a biometric reading, a pseudo random number, a cryptogram, and a digital signature.

According to a second aspect of the invention there is provided a system for authenticating a transaction initiated from a non-internet enabled device by a cardholder, the system comprising:
a mobile operator control means including formatting means for converting a purchase request message received from the non-internet enabled device;
a first network for allowing the mobile operator control means to be in communication with the non-internet enabled device;
a virtual cardholder control means for receiving the converted purchase request message from the mobile operator control means, the converted purchase request message being in a format that is readable by the virtual cardholder control means;
an Issuer access control means for receiving an authentication request message from the virtual cardholder control means, the Issuer access control means being arranged to generate and send a purchase authentication page from back to the virtual cardholder control means;
storage means for storing the purchase authentication page;
prompting means for prompting the cardholder to enter his or her credentials;
converting means for converting the cardholder credentials to a format that is readable by the virtual cardholder control means;
parsing means for parsing the stored purchase authentication page and recognizing the cardholder credential field(s); and
populating means for populating the purchase authentication page with the credentials, with the virtual cardholder control means then being arranged to send the populated purchase authentication page to the Issuer access control means to enable the Issuer access control means to authenticate the cardholder credentials against an account holder database and to then respond to the virtual cardholder control means with an authentication response message.

Typically, the system further includes forwarding means for forwarding the authentication response message to a Merchant control means, which is arranged to decode and validate the authentication response and to then generate an authorization request message and send it to an Acquirer.

### BRIEF DESCRIPTION OF THE DRAWINGS

Features, aspects, and embodiments of the inventions are described in conjunction with the attached drawings, in which:

FIG. 1 shows an online cardholder authentication system in accordance with an example embodiment of the invention; and

FIG. 2 is a diagram illustrating the online cardholder authentication system of FIG. 1 in more detail, configured in accordance with an example embodiment of the invention.

### DESCRIPTION OF PREFERRED EMBODIMENTS

To help better understand the systems and methods described herein, a specific example involving a transaction initiated from a non-internet enabled device over a wireless and wired network is examined below.

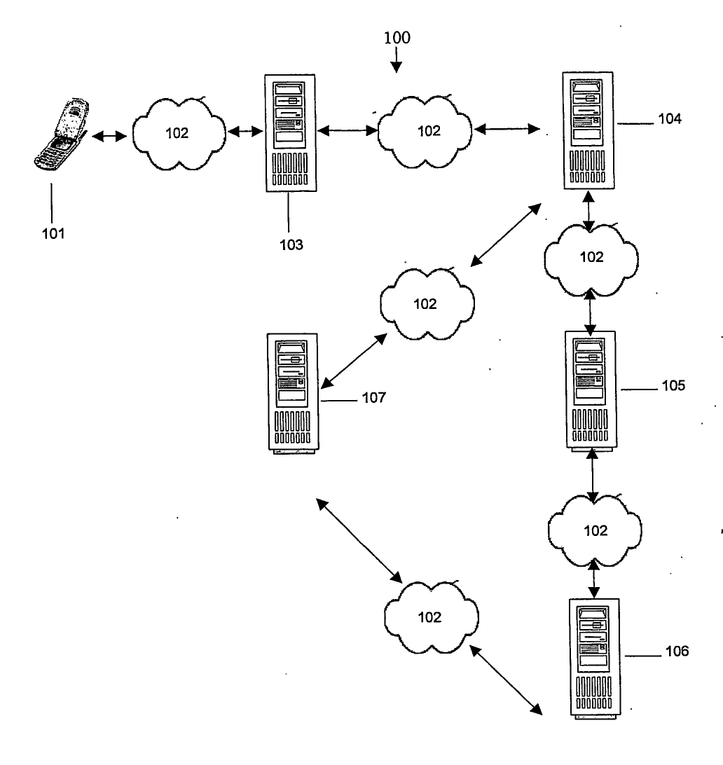

FIG. 1 is a diagram illustrating an example embodiment of an online cardholder authentication system 100 configured in accordance with one embodiment of the system and method described herein. System 100 comprises a non-internet enabled device 101 that is configured to communicate through a wired and/or wireless network 102 with a mobile Operator Server 103. System 100 also comprises a Virtual Cardholder System 104, a Merchant Plug-in 105, a Card Association Directory Service 106 and an Issuer Access Control Server 107.

Device 101 can be any type of device configured to communicate over a wired and/or wireless network, including but not limited to a land-line, mobile phone, smart phone, personal digital assistant or laptop computer.

Network 102 can be any type of wired or wireless network protocol, including but not limited to GSM, CDMA, TDMA, GPRS, 3G, Bluetooth, Infrared, RFID and PSTN, configured to configured to support a range of interactive technologies including but not limited to Voice, DTMF, SMS, STK, USSD1, USSD2, WAP and i-mode.

Accordingly, mobile Operator Server 103, Card Association Directory Service 106 and Issuer Access Control Server 107 can be any type of server configured to support the above, non-internet enabled devices, wireless network protocols and interactive technologies.

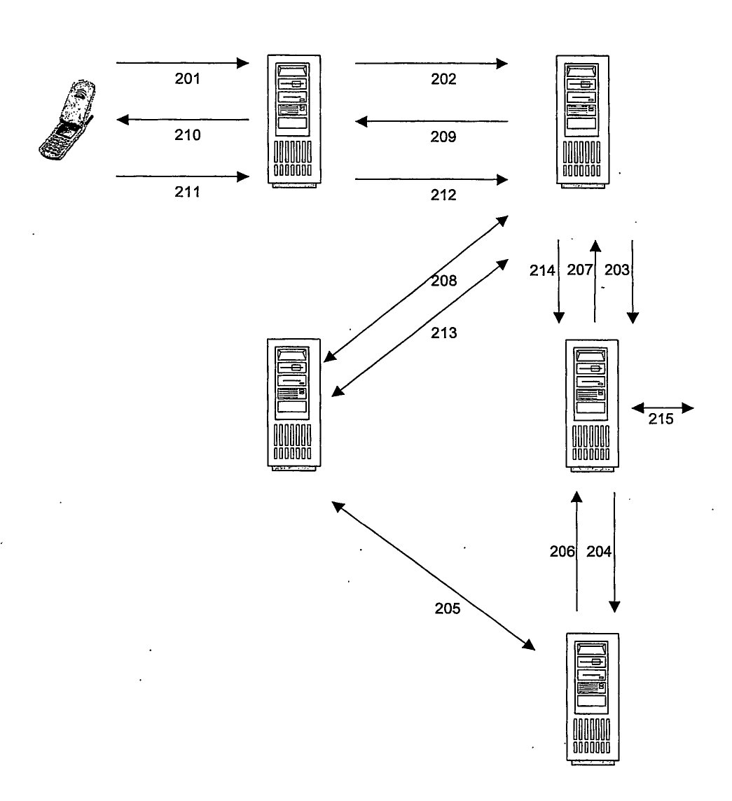

FIG. 2 is a flow chart illustrating an example online cardholder authentication process according to one embodiment of the system and method described herein. The process begins in step 201 when a cardholder dials a telephone number and submits a purchase request message, from a non-Internet enabled device, over network 102 to Operator Server 103 using an appropriate interactive technology.

In step 202 Operator Server 103 formats the purchase request message and sends it to Virtual Cardholder System 104 via a secure channel i.e. SSL, IPSec. The secure channel between Operator Server 103 and Virtual Cardholder System 104 is typically but not always a dedicated leased line.

In step 203 Virtual Cardholder System 104 extracts a unique identifier associated with non-internet enabled device 101 from the purchase request message, matches it with a corresponding value stored on a database, extracts the primary account number (PAN), Expiry Date and Card Verification Value (CW) if credit, retrieves the Merchant Plug-in URL from the purchase request message and simulating an Internet browser starts an http/s session with Merchant Plug-in 105.

The unique identifier could be, but not limited to, any one of the following:
1. An account identifier.
2. A personal identifier, such as a User ID, Password, Personal Identification Number (PIN), or a combination thereof.
3. A token device.
4. A biometric identification.
5. An electronic signature.

In step 204 Merchant Plug-in 105 formats a message and queries Card Association Directory Service 106 on the enrollment status of the PAN.

In step 205 if the PAN is in a participating card range, Card Association Directory Service 106 queries the Issuer Access Control Server 107 to determine whether the PAN is enrolled. Issuer Access Control Server 107 formats a message and responds to the Card Association Directory Service 106 with PAN participation information.

In step 206 Card Association Directory Service 106 forwards the Issuer Access Control Server response to Merchant Plug-in 105.

In step 207 Merchant Plug-in 105 sends a message to Issuer Access Control Server 107 via Virtual Cardholder System 104.

In step 208 Virtual Cardholder System 104 acting on behalf of the cardholder simulates an Internet browser and posts the message to Issuer Access Control Server 107. Issuer Access Control Server 107 responds by sending an HTML purchase authentication page to Virtual Cardholder System 104.

In step 209 Virtual Cardholder System 104 extracts displayable information, stores the HTML page and formats a message which it sends to Operator Server 103.

In step 210 Operator Server 103 translates the message to a format that device 101 understands and requests that the cardholder enter his credentials.

In step 211 the cardholder enters his credentials using the appropriate interactive technology and sends it to Operator Server 103.

In step 212 operator system 103 converts the message to a format that Virtual Cardholder System 104 understands and sends a message containing the cardholder credentials to Virtual Cardholder System 104.

Significantly, in step 213 Virtual Cardholder System 104 acting on behalf of the cardholder extracts the cardholder credentials from the message; parses the stored HTML page recognizing the cardholder credentials field; inserts the cardholder credentials in the appropriate field and posts the HTML purchase authentication page to the Issuer server 107. Issuer Access Control Server 107 accepts the cardholder credentials; authenticates it against the account holder database and responds to virtual access control server 107 with an authentication response message.

In step 214 Virtual Cardholder System 104 simulating an Internet browser forwards the authentication response message to Merchant Plug-in 105.

In step 215 Merchant Plug-in 105 receives and decodes the authentication response, validates the digital signature, generates an authorization request message and sends it to an Acquirer. Merchant Plug-in 105 receives the authorization response message from the Acquirer and forwards it to Virtual Cardholder System 104.

Thus, the present invention provides a method of and system for enabling Issuers, Acquirers and Merchants to use the 3-D Secure™ online cardholder authentication protocol to authenticate cardholders transacting with non-internet enabled devices. The invention operates as a proxy on behalf of the cardholder and simulates a core 3-D Secure™ session to the Merchant Plug-in (MPI) and Issuer Access Control Server (ACS). That is, it converts voice or data based messages received from a non-internet enabled device into a set of messages that are consistent with the requirements of the 3-D Secure™ protocol. Advantageously, the invention can be implemented without Issuers, Acquirers or Merchants having to upgrade or enhance infrastructure.

1-14. (canceled)

15. A method of authenticating a transaction initiated from a mobile device by a cardholder, the method comprising the steps of:
receiving a purchase request message from the mobile device, the purchase request message comprising an identifier for the cardholder and a merchant URL;
extracting the identifier from the purchase request message;
obtaining cardholder data from a database based on the extracted identifier;
connecting with a merchant via the merchant's URL so as to simulate an internet browsing session;
receiving from the merchant an authentication request message;
forwarding the authentication request message to a remote authentication system;
receiving a purchase authentication web page from the authentication system;
extracting displayable information and storing the purchase authentication web page;
forwarding the displayable information to the cardholder and prompting the cardholder to enter his or her credentials;
receiving the cardholder credentials;
parsing the stored purchase authentication web page and recognizing the cardholder credential field(s);
inserting the received cardholder credentials into the purchase authentication web page;
sending the populated purchase authentication web page to the authentication system; and
receiving an authentication response from the authentication system.

16. A system for authenticating a transaction initiated from a mobile device by a cardholders the system comprising a processor that can: receive a purchase request message from the mobile device, the purchase request message comprising an identifier for the cardholder and a merchant URL;
extract the identifier from the purchase request message;
obtain cardholder data from a database based on the extracted identifier;
connect with a merchant via the merchant's URL so as to simulate an internet browsing session;
receive from the merchant an authentication request message; forward the authentication request message to a remote authentication system;
receive a purchase authentication web page from the authentication system;
extract displayable information and storing the purchase authentication web page;
forward the displayable information to the cardholder and prompting the cardholder to enter his or her credentials;
receive the cardholder credentials;
parse the stored purchase authentication web page and recognizing the cardholder credential field(s);
insert the received cardholder credentials into the purchase authentication web page;
send the populated purchase authentication web page to the authentication system; and
receive an authentication response from the authentication system.
